(19) United States
(12) Patent Application Publication
(10) Pub. No.: US 2020/0211478 A1
(43) Pub. Date: Jul. 2, 2020

(54) DISPLAY APPARATUS FOR EYE STRAIN REDUCTION

(71) Applicant: WOODENSHARK LLC, Wilmington, DE (US)

(72) Inventors: Dmitry GORILOVSKY, Wilmington, DE (US); Aleksey DOLGUSHIN, Wilmington, DE (US); Sergey ZINOVYEV, Wilmington, DE (US); Andrey GADZHALA, Wilmington, DE (US)

(21) Appl. No.: 16/811,591

(22) Filed: Mar. 6, 2020

Related U.S. Application Data
(63) Continuation of application No. 15/772,204, filed on Apr. 30, 2018, now abandoned.

(30) Foreign Application Priority Data
Oct. 30, 2015 (GB) 1519171.1

(51) Int. Cl. G09G 3/34; G09G 3/00; H05B 47/155; H05B 45/20

(52) U.S. Cl. CPC G09G 3/34; G09G 3/3413; G09G 3/001; H05B 47/155; G09G 2360/16; G09G 2360/14; G09G 2354/00; G09G 2310/0232; H05B 45/20

(57) ABSTRACT

There is disclosed an apparatus including a backlighting processor unit (BPU), and a colour illumination system which is connectable to the backlighting processor unit, the colour illumination system attachable to a reverse side of a display, wherein the display is positionable facing away from a vertical surface, the backlighting processor unit arranged to receive a display frame and to transmit the display frame to the display, the backlighting processor unit further arranged to process the display frame, and to control the colour illumination system to output a colour, at an intensity, wherein the colour is obtained from the processing of the display frame, the output colour being output at the intensity towards the vertical surface.

### CROSS REFERENCE TO RELATED APPLICATIONS

This application is a continuation of U.S. application Ser. No. 15/772,204, filed on Apr. 30, 2018, which claims the priority of PCT/GB2016/053378, filed on Oct. 31, 2016, which claims priority to GB Application No. GB1519171.1, filed on Oct. 30, 2015, the entire contents of which being fully incorporated herein by reference.

### BACKGROUND OF THE INVENTION

### 1. Field of the Invention

The field of the invention relates to display apparatus for eye strain reduction.

### 2. Technical Background

Human beings are spending increasing amounts of time viewing display screens, whether at work, or during their leisure time. It is well known that spending excessively long periods of time viewing screens increases the risk of eye strain. Yet technical solutions to the problem of eye strain are not applied very much. Users are recommended to take breaks from viewing screens, for example, to reduce eye strain risk. But it would be better if the screens themselves were technically suited to reduce the risk of eye strain, to reduce the emphasis on the user to take remedial action.

### 3. Discussion of Related Art

U.S. Pat. No. 5,432,504(A), entitled “Visual display terminal device & method for eye strain reduction,” discloses a device for a video screen which includes a support member disposed about the circumference of the video screen. The support member has walls with interior reflective surfaces. A plurality of point light sources or lamps are mounted to the support member and positioned to provide inner and outer concentric frames of light on the screen. The inner frame comprises a series of discrete point light images or dots near the circumference of the screen formed by light from the light sources being cast directly onto the screen. The outer frame comprises a series of discrete point light images or dots near the circumference of the screen formed by light from the light sources first reflecting off the reflective surfaces and then onto the screen. The intensity of the light from the inner frame is less than the intensity of light from the outer frame.

JP2007319380 (A), English Abstract, discloses a game machine which can reduce a user's eye strain during a game. The game machine has an adjustment key to adjust the contrast of a liquid crystal display screen on the front of a panel display section, and can reduce eye strain during a game by adjusting the contrast by an adjustment amount input by a player and instructed by the adjustment key during the display of a menu on the screen only when a contrast adjustment is permitted by an adjustment permission key provided on the rear side of the panel displays section.

However, user eye strain may still occur when viewing a screen with a changing brightness, in a darkened room. There is a need for an improved arrangement in relation to a display to reduce user eye strain.

### SUMMARY OF THE INVENTION

According to a first aspect of the invention, there is provided an apparatus including a backlighting processor unit (BPU), and a colour illumination system which is connectable to the backlighting processor unit, the colour illumination system attachable to a reverse side of a display, wherein the display is positionable facing away from a vertical surface, the backlighting processor unit arranged to receive a display frame and to transmit the display frame to the display, the backlighting processor unit further arranged to process the display frame, and to control the colour illumination system to output a colour, at an intensity, wherein the colour is obtained from the processing of the display frame, the output colour being output at the intensity towards the vertical surface.

An advantage is that user eye strain is reduced because when the display is used in a dark room, a sharp intensity drop at the edge of the display is avoided, which helps to reduce eye strain. Instead the colours seen beyond the edge of the display are related to those seen on the display, and the intensity is seen to fall off smoothly beyond the edge of the display, which helps to reduce eye strain. To some extent, a reduction in eye strain can be expected, even in partially lit rooms.

The apparatus may be one wherein the colour is obtained from the processing of the display frame, using an averaging process for at least a portion of the display frame. An advantage is that colour levels may be better matched either side of the edge of the display.

The apparatus may be one wherein the intensity is obtained from the processing of the display frame. An advantage is that intensity levels may be better matched either side of the edge of the display.

The apparatus may be one wherein the intensity is obtained from the processing of the display frame, using an averaging process for at least a portion of the display frame. An advantage is that intensity levels may be better matched either side of the edge of the display.

The apparatus may be one including a light intensity sensor outputting a light intensity reading, wherein the intensity is obtained from processing the light intensity reading. The light intensity sensor may be used to adjust an overall brightness of the system, e.g., turn the system to full power in the light of day and dim it at night.

The apparatus may be one wherein the backlighting processor unit (BPU) includes a plurality of input ports.

The apparatus may be one wherein the plurality of input ports include a plurality of HDMI input ports.

The apparatus may be one wherein the display frame is selectable from the plurality of input ports.

The apparatus may be one wherein the colour illumination system comprises a single LED light output module.

The apparatus may be one wherein the single LED light output module comprises a RGB LED assembly in a plastic housing with a transparent top part.

The apparatus may be one wherein the single LED light output module includes an adhesive layer at the bottom.

The apparatus may be one wherein the colour illumination system comprises a plurality of light output sources.

The apparatus may be one wherein the colour illumination system comprises a plurality of light sources, wherein the colour of each respective light source is selected by the BPU as a result of analyzing a respective zone of the display frame which is closest to the respective light source. The apparatus may be one wherein the colour illumination system comprises a plurality of light sources, wherein the colour and intensity of each respective light source is selected by the BPU as a result of analyzing a respective zone of the display frame which is closest to the respective light source.

The apparatus may be one wherein processing includes capturing pixel areas along the border of an image and obtaining an average (e.g. a median, mean or mode) color of each of these areas.

The apparatus may be one wherein these colors are then displayed at a respective light source module on the back of the display screen.

The apparatus may be one wherein all the light sources on the back of the display device work together to illuminate e.g. a wall behind the display making an image which extends screen borders and provides a light gradient between a bright image on the display and a dark ambient of a room.

The apparatus may be one wherein the gradient helps to relieve eye strain and make a visually larger picture.

The apparatus may be one wherein the colour illumination system comprises a chain of LED light output modules.

The apparatus may be one wherein each chain element module comprises RGB LEDs assembled in a plastic housing with a transparent top part.

The apparatus may be one wherein each chain element module has an adhesive layer at the bottom.

The apparatus may be one wherein the colour illumination system comprises clip-comers and a set of LED strips, in which the set of LED strips are connectable using the clip-corners.

The apparatus may be one wherein the set of LED strips is 1 m to 5 m in length.

The apparatus may be one wherein the set of LED strips is 5 m to 10 m in length.

The apparatus may be one wherein each clip corner includes a PCBA (printed circuit board assembly) with a microcontroller.

The apparatus may be one wherein each clip corner is assembled in a plastic housing with plastic clamping clips, which makes a secure electrical connection and mechanically fastens strips inside the clip-corner.

The apparatus may be one wherein each clip-corner and each LED strip has an adhesive layer at the bottom.

The apparatus may be one wherein the LEDs are organic light emitting diodes (OLEDs).

The apparatus may be one wherein the apparatus includes a plurality of light emitting boxes, which are connectable to the BPU.

The apparatus may be one wherein the plurality of light emitting boxes includes a light emitting toroidal polyhedron.

The apparatus may be one wherein the light emitting toroidal polyhedron is a cuboidal light emitting toroidal polyhedron.

The apparatus may be one wherein the light emitting toroidal polyhedron includes a housing, the housing including a top part which is hollow and made of a semi-transparent plastic, while a housing bottom part is opaque white polycarbonate and has a compartment for a printed circuit board (PCB) and LEDs.

The apparatus may be one wherein the plurality of light emitting boxes includes a plurality of cubic or cuboidal light emitting boxes.

The apparatus may be one wherein the plurality of light emitting boxes includes LED light sources.

The apparatus may be one wherein the plurality of light emitting boxes includes respective USB sockets.

The apparatus may be one wherein the plurality of light emitting boxes each has a housing top part which is hollow and made of a semitransparent plastic, while the bottom part is opaque white polycarbonate and includes a compartment which includes a PCB and a battery.

The apparatus may be one wherein RGBW LED lights are situated on the top of the bottom part, and the light is dissipated in the top part, making the light emitting box housing top part glow.

The apparatus may be one wherein each light emitting box device lights up with an average (e.g. median, mean or mode) color of a picture being shown on the display, e.g. if picture's overall luminosity is higher than a threshold value.

The apparatus may be one wherein each light emitting box device lights up with an average (e.g. median, mean or mode) color of the picture area which it is assigned to.

The apparatus may be one wherein the particular color and time of turning on and off of each light emitting box device is determined algorithmically, using display picture dynamics.

The apparatus may be one wherein each light emitting box device has an accelerometer and a gyroscope which are usable in a setup process.

The apparatus may be one wherein the BPU device determines the position of each connected LEB relative to the display screen, based on data gathered from the LEB's accelerometer and gyroscope while a user sets up each LEB.

The apparatus may be one wherein the BPU is configured to recognize gestures recorded using a LEB. Recognized gestures may include: tap, double tap, rotate, shake. Actions that a user can initiate with recognized gestures may include:
setup zones on BPU LED ribbon that LEB is responsible for;
switch between LEB modes;
setup LEB brightness and colour.

The apparatus may be one wherein the apparatus includes a charging station, for charging LEBs.

The apparatus may be one wherein the apparatus includes a remote control, suitable for controlling the BPU.

The apparatus may be one wherein the remote control is usable to choose a desired input.

The apparatus may be one wherein the remote control is a suitably programmed mobile computing device.

The apparatus may be one wherein the mobile computing device is a smartphone or a tablet computer or a smartwatch.

The apparatus may be one wherein the remote control is operable to control the BPU, wirelessly.

The apparatus may be one wherein the remote control is operable to control the BPU, wirelessly, using WiFi or Bluetooth.

The apparatus may be one wherein the remote control 1s operable to control LEB devices in connection with the BPU.

The apparatus may be one wherein the BPU is configured to provide room lighting, when the display screen is off.

The apparatus may be one wherein the room lighting changes with time according to an algorithm in the BPU.

The apparatus may be one wherein the BPU includes an open application programming interface (API).

The apparatus may be one wherein the BPU is configured to automatically detect screen size.

The apparatus may be one wherein the BPU includes a FPGA.

The apparatus may be one wherein the BPU includes a MCU.

The apparatus may be one wherein the technology allows the BPU to obtain the average (e.g. median, mean or mode) color values for a high quantity of capturing areas from a wide variety of image resolutions.

The apparatus may be one wherein the resolution of a given picture is detected the moment when it is changed by a source.

The apparatus may be one wherein the BPU includes a Bluetooth module.

The apparatus may be one wherein the BPU does not require a separate computer.

The apparatus may be one wherein the BPU is connectable to a smart home hub.

The apparatus may be one wherein the BPU includes an integral smart home hub.

The apparatus may be one wherein a mobile computing device is connectable to the smart home hub to provide a remote control to control the BPU.

The apparatus may be one wherein the BPU is configured to control lighting via the smart home hub.

The apparatus may be one wherein the smart home hub is a USB stick.

The apparatus may be one wherein the smart home hub is connected to a IFTTT (If This Then That) web-based service.

The apparatus may be one wherein the BPU supports custom settings for display delay.

The apparatus may be one wherein the BPU is connectable between a HDMI (High-Definition Multimedia Interface) audio-video source and the display. The BPU may switch active sources automatically depending on current state of TV and sources plugged into BPU.

The apparatus may be one wherein the BPU is configured to process HDMI display data.

The apparatus may be one wherein the BPU requires auxiliary power and is provided with a mains power adapter.

The apparatus may be one wherein the BPU captures and processes a video signal in real-time.

The apparatus may be one wherein the BPU feeds the video signal to the display in its original form.

The apparatus may be one wherein the BPU device can set itself up m semi-auto or manual modes.

The apparatus may be one wherein if an assembly of LED Strip and Clip-Corners is installed, the BPU device sets itself up in a semi-auto mode: the BPU turns the modules on in a serial order, starting from the first one, and modules which are not yet lighted up, are off and not powered up, and when the turn comes to a Clip-Corner, its controller sends a signal to the BPU base device indicating that it is on now, and counting these feedback signals, the BPU device obtains the number of modules mounted vertically and horizontally, and the position of the first Clip-Corner relative to the display screen is received.

The apparatus may be one wherein the apparatus includes a box that contains sensors.

The apparatus may be one wherein the sensors include one or more of: a microphone, a light sensor and a motion sensor.

The apparatus may be one wherein the box that contains sensors transmits sensor data to the BPU.

According to a second aspect of the invention, there is provided a method of installing an apparatus including a backlighting processor unit (BPU), and a colour illumination system which is connectable to the backlighting processor unit, wherein the backlighting processor unit is arranged to receive a display frame and to transmit the display frame to the display, the backlighting processor unit further arranged to process the display frame, and to control the colour illumination system to output a colour, at an intensity, wherein the colour and the intensity are obtained from the processing of the display frame, the output colour being output at the intensity towards a vertical surface, the method comprising the steps of:

10 (i) attaching the colour illumination system to a reverse side of a display, wherein the display is positionable facing away from the vertical surface, and

(ii) connecting the colour illumination system to the BPU.

The method may be one wherein the colour illumination system comprises a plurality of light output sources, and wherein each light output source is mounted to the back of the display along a screen border.

The method may be one wherein the colour illumination system comprises a chain of LED modules, and wherein each module is mounted to the back of the display along a screen border.

The method may be one wherein the colour illumination system comprises LED strips and Clip-Comers, wherein the LED strips comprise four segments which are clamped in clip-comers, and in which the colour illumination system is mounted to the back of the display along a screen border.

According to a third aspect of the invention, there is provided a display apparatus including a screen, a backlighting processor unit (BPU), and a colour illumination system in connection with the backlighting processor unit, the colour illumination system situated on a reverse side of the display apparatus to the screen, wherein the display is positionable with the screen facing away from a vertical surface, the backlighting processor unit arranged to receive a display frame and to transmit the display frame to the screen, the backlighting processor unit further arranged to process the display frame, and to control the colour illumination system to output a colour, at an intensity, wherein the colour is obtained from the processing of the display frame, the output colour being output at the intensity towards the vertical surface.

The display apparatus may be configured to include apparatus of any aspect of the first aspect of the invention.

### BRIEF DESCRIPTION OF THE FIGURES

Aspects of the invention will now be described, by way of example(s), with reference to the following Figures, in which:

FIG. 1 shows an example of a backlighting processor unit (BPU). (a) shows a BPU example from the input side. (b) shows a BPU example from the output side. (c) shows example BPU input ports. (d) shows example BPU output ports.

FIG. 2 shows an example of a single LED light output module.

FIG. 3 shows an example of a single LED light output module which has been mounted on the reverse side of a display.

FIG. 4 shows (a) an example of a first chain element of LED light output modules, and (b) an example of a last chain element of LED light output modules.

FIG. 5 shows an example of a chain of LED light output modules which has been mounted on the reverse side of a display.

FIG. 6 shows examples of clip-corners (a) and (b), and of clip-corner structures ((c) to (f)).

FIG. 7 shows an example of assembling a strip segment inside a clip-corner.

FIG. 8 shows an example of LED strips with clip-corners which have been mounted on the reverse side of a display.

FIG. 9 shows a backlighting processor unit (BPU) system functionality overview example.

FIG. 10 shows a light emitting toroidal polyhedron example, which is an example of a light emitting box.

FIG. 11 shows a light emitting toroidal polyhedron assembly example.

FIG. 12 shows a light emitting toroidal polyhedron alternative ultra-bright assembly example.

FIG. 13 shows a light emitting box (LEB) example. (a) is the normal, closed configuration. (b) is an open configuration, showing a LED light source inside the LEB.

FIG. 14 shows an example of a use of wall-mounted light emitting boxes, and a monitor.

FIG. 15 shows an example of a remote control.

FIG. 16 shows an example of controlling a BPU device from a smartphone or tablet application e.g. via WiFi or Bluetooth.

FIG. 17 shows an example of controlling LEB devices directly from a smartphone or tablet application e.g. via WiFi or Bluetooth.

FIG. 18 shows an example of Controlling LEB devices via the Internet.

FIG. 19 shows an example of Controlling third-party smart lightbulbs from a BPU.

FIG. 20 shows an example of a Smart Home hub.

FIG. 21 shows an example of BPU system connectivity.

FIG. 22 shows an example in which a BPU device automatically detects screen size.

FIG. 23 shows an example of a BPU device.

FIG. 24 shows some remote control examples.

FIG. 25 shows an example in which zones are extracted from a screen frame.

FIG. 26 shows an example in which the viewer can view a screen picture and associated coloured backlighting.

FIG. 27 shows an example of BPU internal hardware.

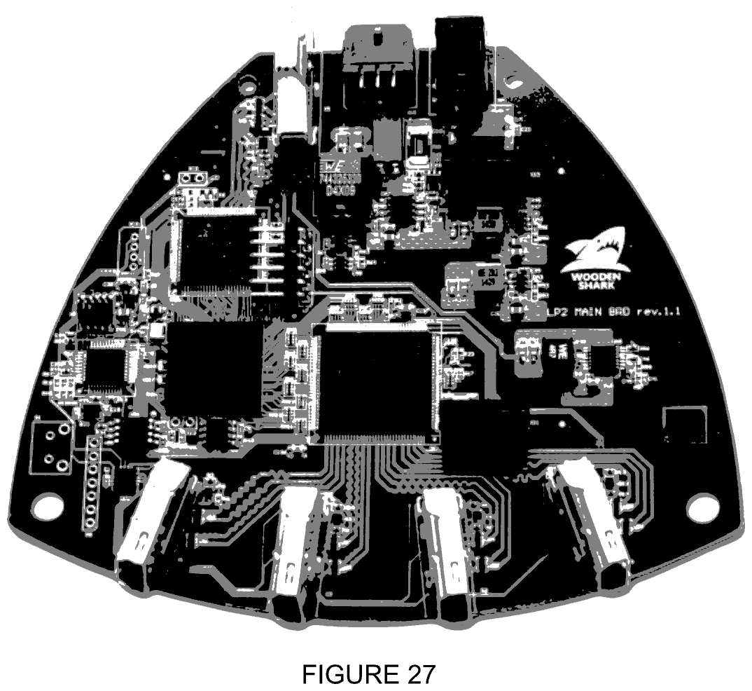

### DETAILED DESCRIPTION

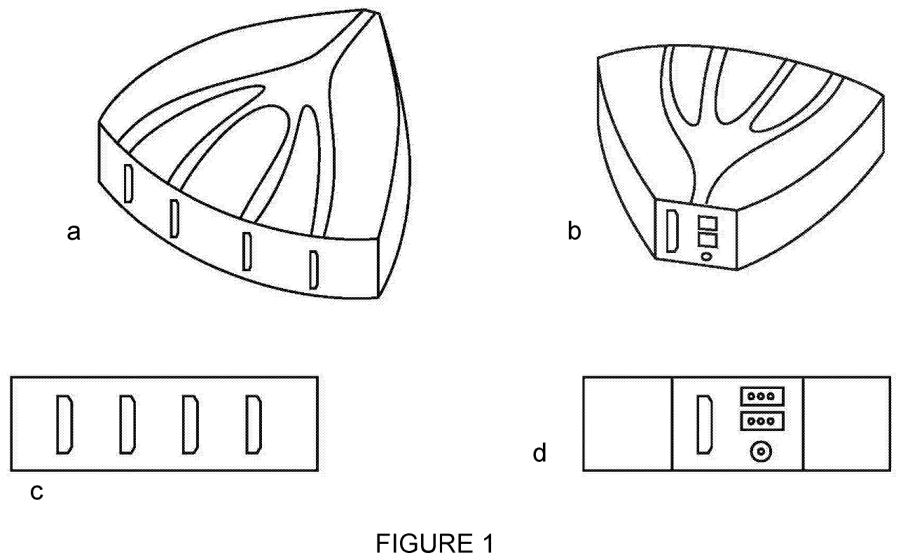

A backlighting processor unit (BPU) is a device which may be connected between a HDMI (High-Definition Multimedia Interface) audio-video source and a TV display. A HDMI audio-video source device can be e.g. a video player, gaming console, personal computer (PC), etc. See FIG. 1 for example. For example, one of three lighting solutions may also be connected to the backlighting processor unit (BPC), which are described below.

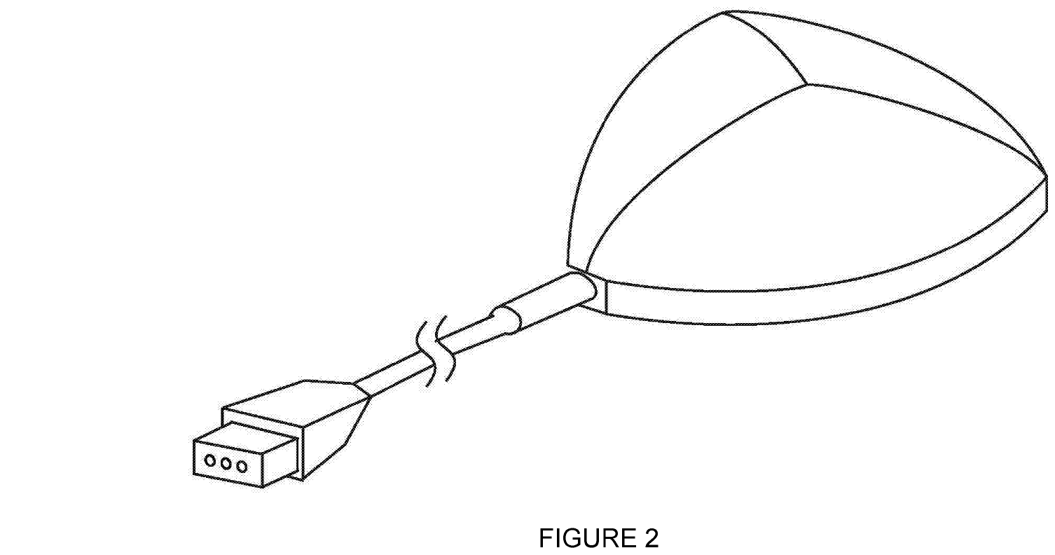

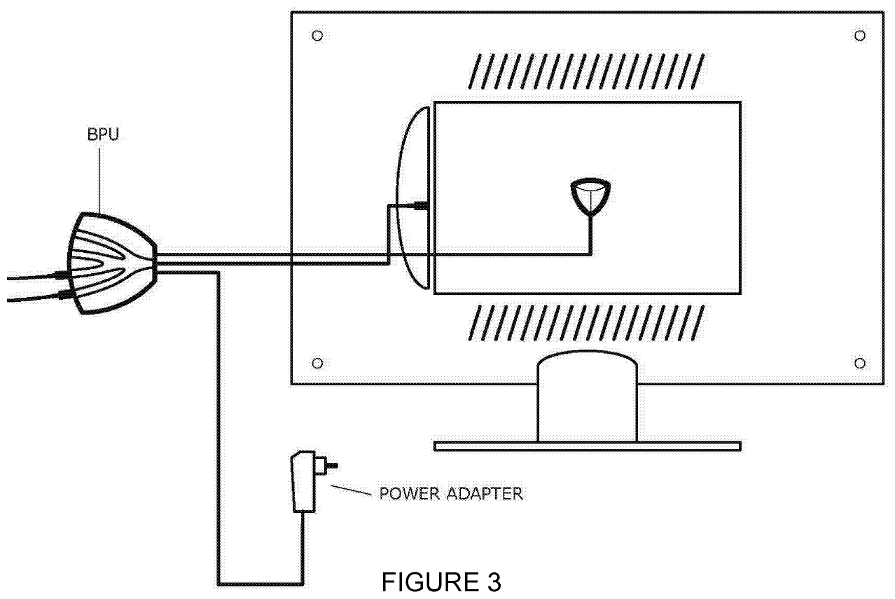

1. A single light emitting diode (LED) module includes an ultra-bright RGB LED assembly in a plastic housing with a transparent top part (see FIG. 2 for example). The module may have an adhesive layer at the bottom and it could be mounted on the back of a TV e.g. at the center (see FIG. 3 for example).

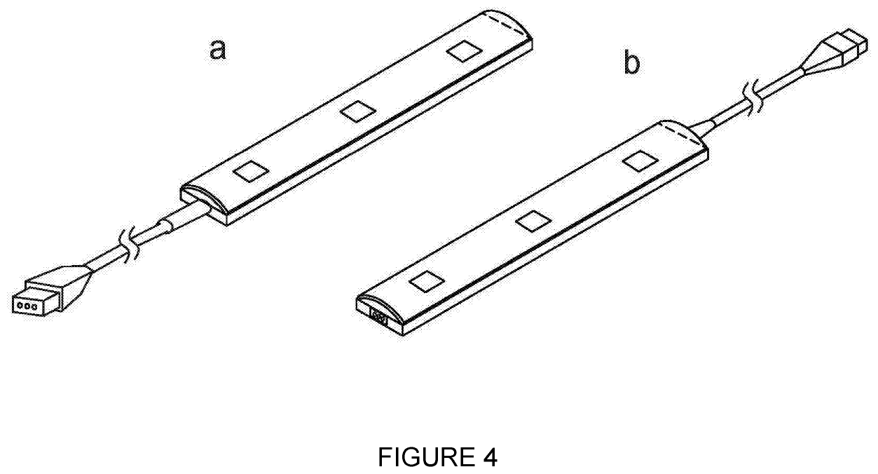

2. A chain of LED modules. Each module is e.g. a set of three RGB LEDs assembled in a plastic housing with a transparent top part. The module may have a 3-pin Microfit-type socket on one side and a cable with male 3-pin jack of same type on the other side. First module in the chain connects to the BPU base device, the next module connects to the first one, and so on. Last module connects to the BPU base. See FIG. 4 for (a) an example of a first chain element, and (b) an example of a last chain element.

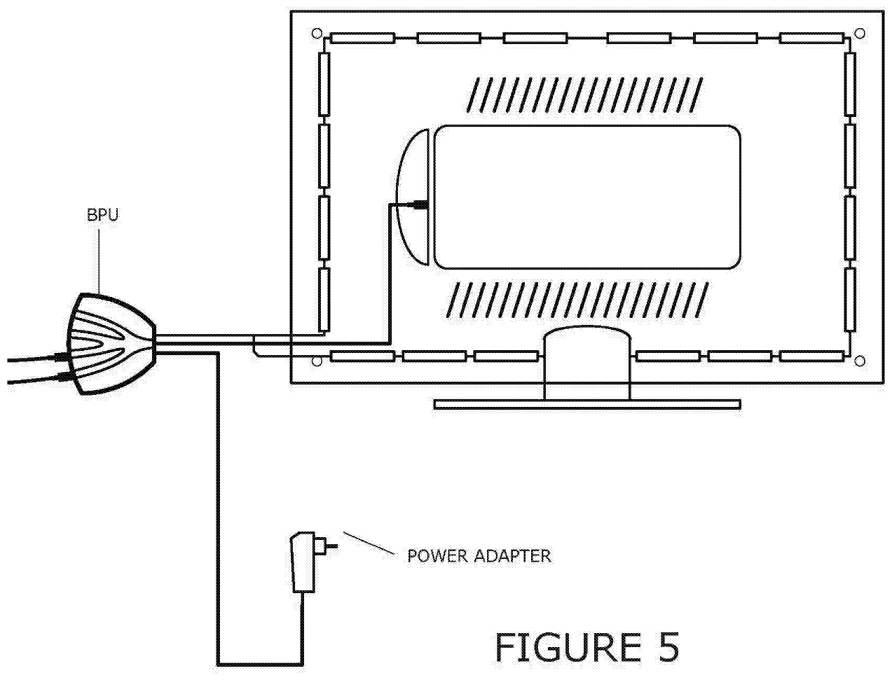

Chain element modules may have an adhesive layer at the bottom and they may be mounted to the back of a TV along the screen border (see FIG. 5 for example).

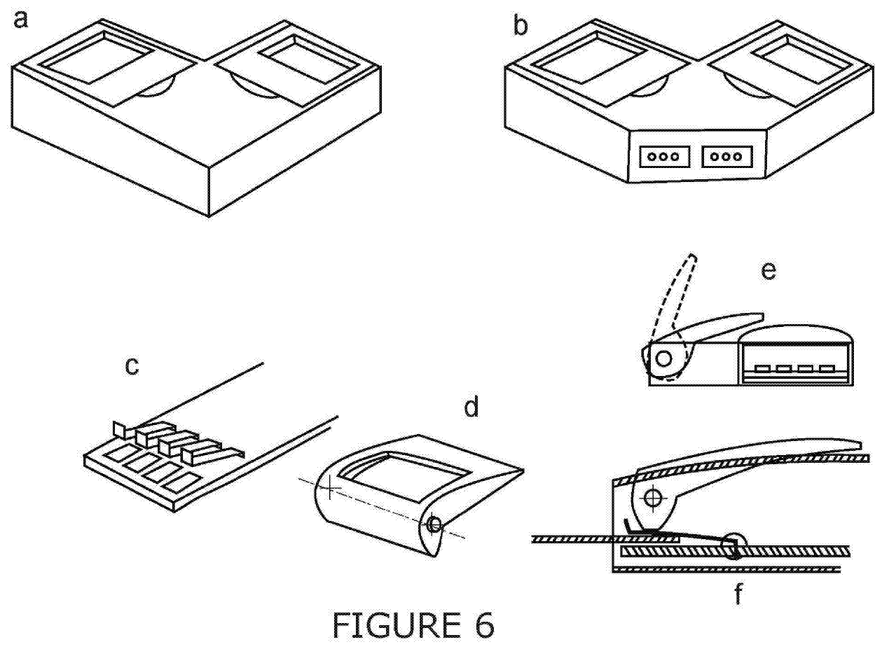

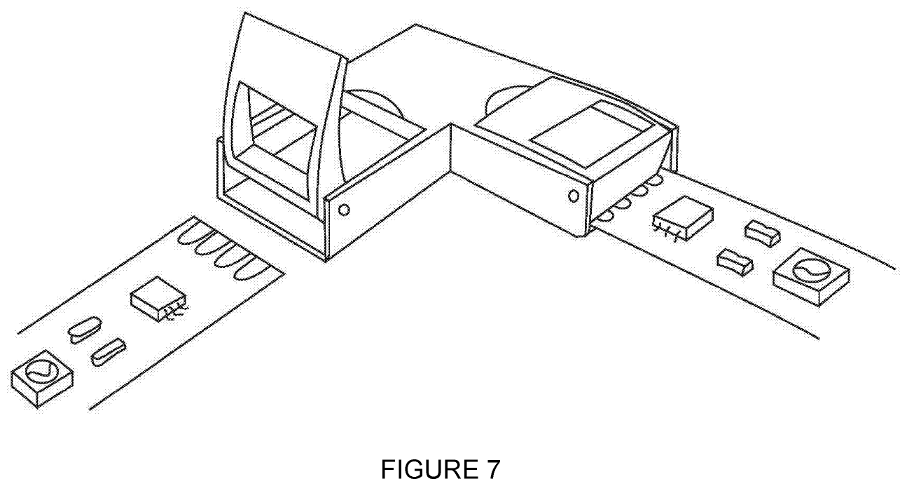

3. A LED strip with clip-comers assembly (see FIG. 6 for example). An LED strip is cut to four segments of desired lengths and is clamped in clip-comers. Each clip-comer has a PCBA (printed circuit board assembly) with a microcontroller and is assembled in a plastic housing with plastic clamping clips, which makes a secure electrical connection and mechanically fastens the strip inside clip-comer (see FIG. 7 for example).

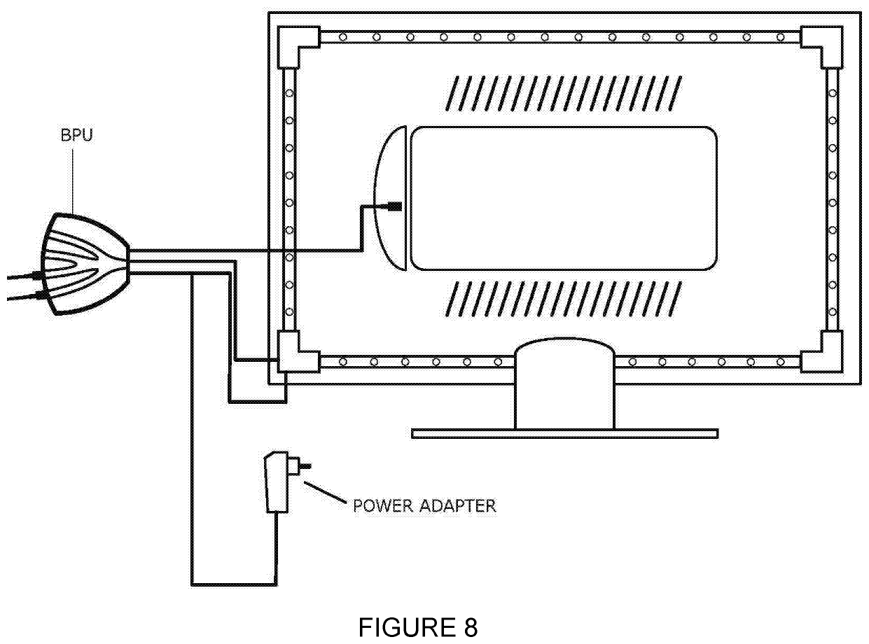

Each clip-comer and the whole LED strip may have an adhesive layer at the bottom and could be mounted to the back of a TV along the screen border. The first (index) clip-corner may have two 3-pin Microfit-type sockets (see e.g. FIG. 6 (b)) and may be connected to the BPU base device (see FIG. 8 for example).

The BPU may need auxiliary power and may be provided with a mains power adapter such as a 120V or 220V adapter. A BPU set may also include a 5-button remote which connects with the device via Bluetooth Low Energy. The remote may be used to choose the desired HDMI input.

### BPU System Functionality Overview

A video signal may be captured and be processed by a BPU in real-time and may be fed to the TV in its original form. Processing may be made to capture pixel areas along the border of an image and obtain an average (e.g. a median, mean or mode) color of each of these areas. These colors are then displayed at a respective LED module on the back of the TV screen. All the LEDs on the back of the display device work together to illuminate e.g. a wall behind a TV making an image which extends screen borders and provides a light gradient between a bright image on the display and a dark ambient of the room. This gradient helps to relieve eye strain and make a visually larger picture. If the Single LED Module is used, the capturing area is a single area and equals the whole displayed image.

A BPU may use a field-programmable gate array (FPGA) controlled by a generic microcontroller. The technology allows the BPU to obtain the average (e.g. median, mean or mode) color values for a high quantity of capturing areas from a wide variety of image resolutions: e.g. from 320×240px and up to e.g. 1920×1080p. The resolution of a given picture is detected the moment when it is changed by HDMI source, and all the capturing areas are scaled to fit the new resolution (e.g. the area's width equals picture width divided by horizontal module number, and the height equals picture height divided by vertical module number).

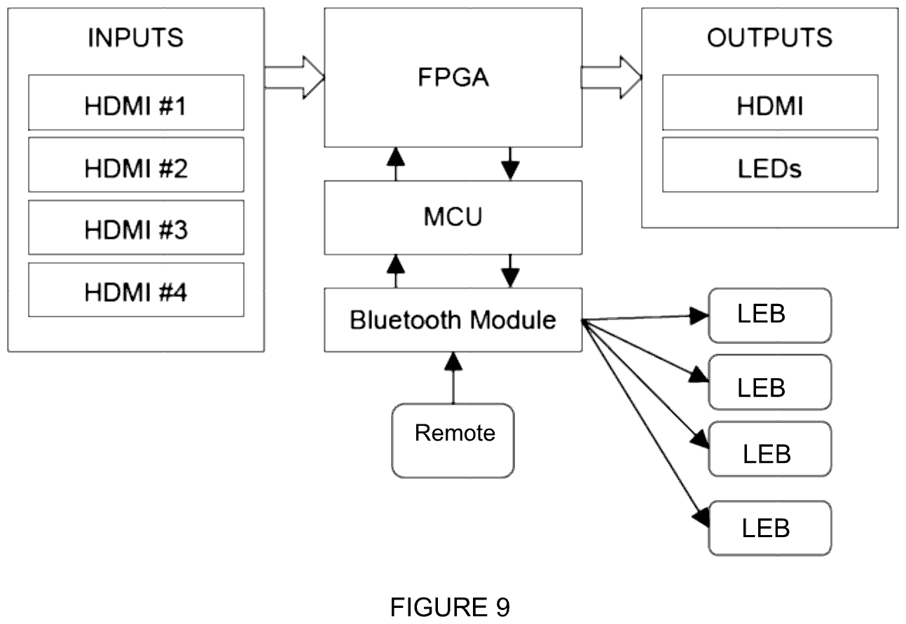

FIG. 9 shows a BPU system functionality overview example.

Installing the BPU system

The BPU installing process may start with assembling and mounting the LED modules or LED strip onto the back of a TV.

If the Single LED module is being installed, it may be mounted on the back of a TV at the center, and then is connected to the base BPU device. If the Chain of LED modules is being installed, each module may be mounted to the back of a TV along the screen border. Each module connects to the previous one in the chain while the first and the last modules are connected to the BPU base device. If the assembly of LED Strip and Clip-Corners is being installed, the LED strip is cut to four segments of desired lengths and is clamped in clip-corners. The whole loop is then mounted to the back of a TV along the screen border. The first (index) clip-corner connects to the BPU base device.

After the LED modules or strip is installed and connected, the required HDMI sources are connected to the BPU base device's HDMI inputs and a TV is connected to the BPU's HDMI output. The power adapter connects to the BPU electrical input socket and the BPU device powers up and is set up.

The BPU device can set itself up in e.g. semi-auto or manual modes depending on which lighting solution is chosen. In an example, there are three parameters to be set up:
the number of LED modules installed horizontally on top and bottom of the TV screen;
the number of LED modules installed vertically on left and right of the TV screen;
the position of the first (index) LED module or clip-corner relative to the TV screen.

If the single LED module is installed, the BPU device detects it automatically and sets the vertical and horizontal numbers to one and the indexing position to center. The BPU will then process the whole sourced image and light up the single LED module with the average (e.g. median. mean or mode) color.

If the Chain of LED modules is installed, the user should enter the exact number of horizontal and vertical modules manually, e.g. using the 5-button remote.

If the assembly of LED Strip and Clip-Corners is installed, the device sets itself up in a semi-auto mode: the BPU will turn the modules on in a serial order, starting from the first one. Therefore, modules which are not yet lighted up, are off and not powered up. When the turn comes to a Clip-Corner, its controller sends a signal to the BPU base device indicating that it is on now. Counting these feedback signals, the BPU device obtains the number of modules mounted vertically and horizontally. Then the only thing a user needs to do is to enter the position of the first (index) Clip-Corner relative to the TV screen.

### Light Emitting Devices

### Light Emitting Toroidal Polyhedron

The light emitting toroidal polyhedron is a static environment lighting device. It could be sold separately or in a set including four light emitting cuboidal boxes. A light emitting toroidal polyhedron is an example of a light emitting box.

The light emitting toroidal polyhedron may not have a battery and may plug directly into a standard electricity socket. The light emitting toroidal polyhedron may come with two power cords: white and black, so a user can choose whichever to use with his room's interior. The light emitting toroidal polyhedron may be controlled by a BPU device via Bluetooth Low Energy and can work in two modes:
as the BPU slave device, changing its color to an average (e.g. median, mean or mode) color of a picture shown on the TV screen;
as the environment lighting device, glowing with a color chosen by user.

The light emitting toroidal polyhedron may be a 280×280×50 mm white ring. The top part of the housing may be hollow and made of a semi-transparent plastic, while the bottom part may be opaque white polycarbonate and may have a compartment for a printed circuit board (PCB) and LEDs. The RGBW (red green blue white) LEDs light is dissipated in the top part, making the whole light emitting toroidal polyhedron housing glow.

The LEDs could be also assembled on top and bottom layers of a flex-rigid PCB fixed with small fixators to the bottom part of the housing. That way the whole housing is semi-transparent and glows as a whole.

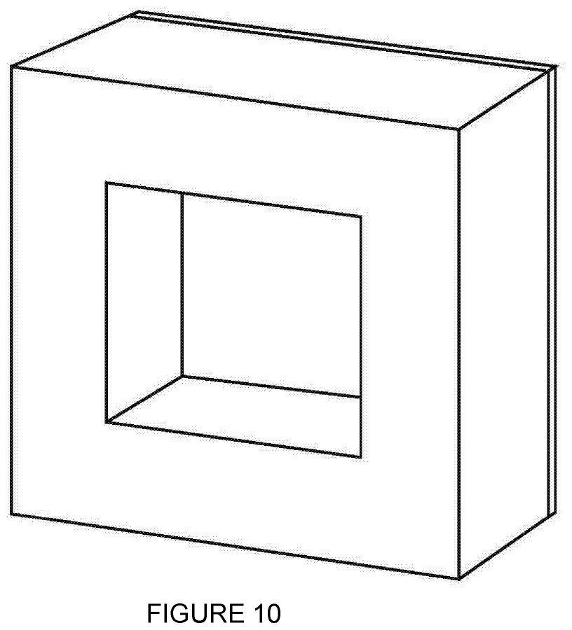

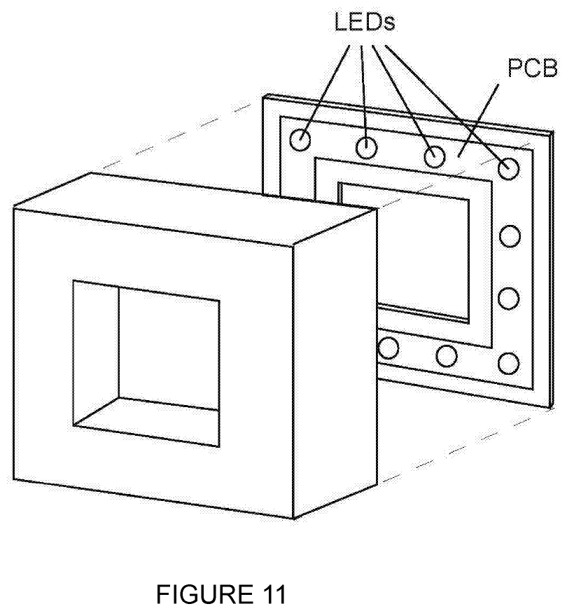

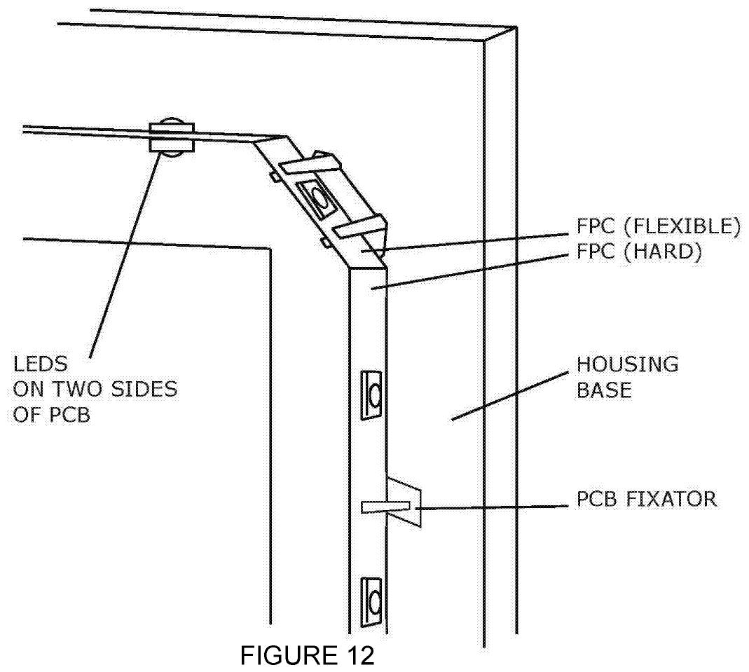

FIG. 10 shows a light emitting toroidal polyhedron example. FIG. 11 shows a light emitting toroidal polyhedron assembly example. FIG. 12 shows part of a light emitting toroidal polyhedron alternative ultra-bright assembly example.

### Light Emitting Boxes

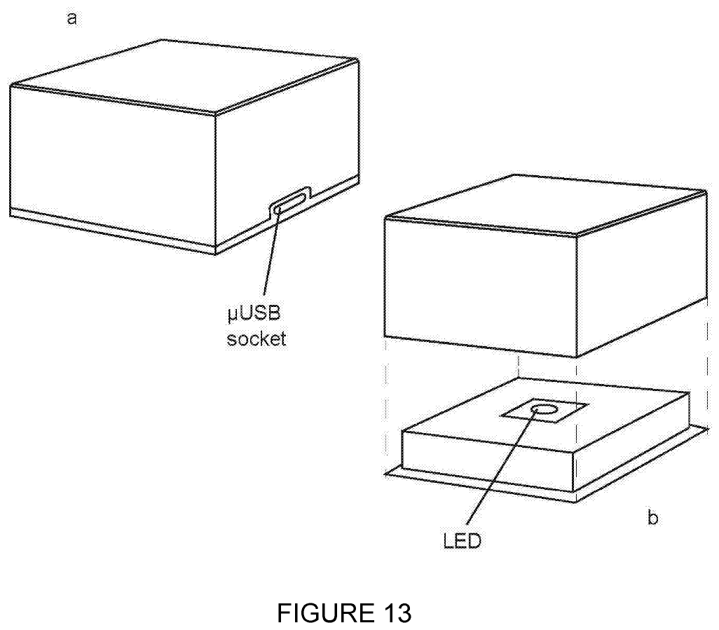

Light emitting boxes are a set of dynamic interactive lighting devices. A light emitting box (LEB) device may be a cubic box or a cuboidal box. A light emitting box (LEB) device may be a cuboidal 70×70×50 mm white box. The top part of the box may be hollow and made of a semitransparent plastic, while the bottom part may be opaque white polycarbonate and may have a compartment for a PCB and battery. The RGBW LED lights may be situated on the top of the bottom part, and the light may be dissipated in the top part, making the whole light emitting box housing glow. The light emitting box could be mounted on a wall with a simple plastic hook, or it could be put on a shelf or anywhere a user wants. FIG. 13 shows a light emitting box example.

Each light emitting box device may connect to the BPU main device and may blink or glow in two basic modes:
Simple mode: each LEB lights up with an average (e.g. median, mean or mode) color of a picture being shown on a TV screen, e.g. if picture's overall luminosity is higher than a threshold value. This mode doesn't require the initial position setup process.
Advanced mode: each LEB lights up with an average (e.g. median, mean or mode) color of the picture area which it is assigned to. As different LEBs could be different distances from the TV screen, the particular color and time of turning on and off may be predicted algorithmically, using the TV picture dynamics at the moment. E.g. if a bright object moves on the screen from left to right on a dark background, the algorithm will find it and recognize its shape and velocity, and then LEBs which are positioned to the right of the TV screen will light up at the moment when this bright object “overlaps”, as if there was a bigger screen.

Advanced mode requires all LEBs to be set up before using. The process of setting LEBs up is described below at the respective paragraph.

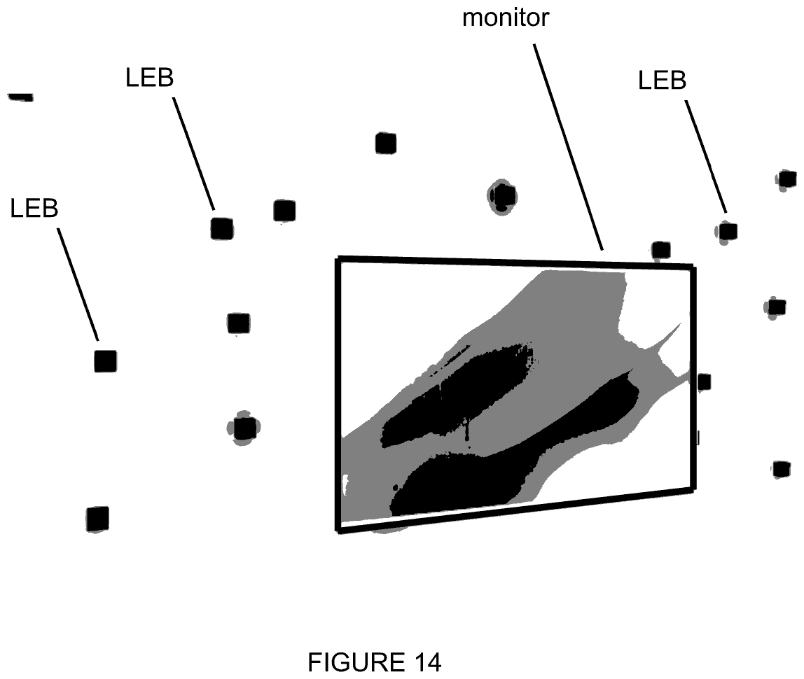

In an example, each LEB has three rechargeable 18650 batteries with total capacity of 9000 mAh, and μUSB socket for battery charging. Also, each LEB may have an accelerometer and a gyroscope which may be used in the setup process and in other interactivities. For example, if a user shakes the LEB, it may glow with a color corresponding to its current battery level—e.g. red for almost empty battery and bright green for full battery. FIG. 14 shows a LEB usage example, in which LEBs are mounted on a wall behind a monitor.

### Installing LEBs

To make LEBs work in Advanced mode, an initial setup is required. Technically, what the BPU device needs to know is the position of each connected LEB relative to the TV screen. This calculation may be made on the basis of data gathered from an LEB's accelerometer and gyroscope while a user sets up each LEB, moving it from the “zero point” (top center of the TV screen) to a desired place: e.g. a wall behind the TV, a shelf, a floor, etc.

As the LEBs' batteries need to be charged from time to time, a user will have to remove the LEBs, charge them and then arrange them again. To avoid repetition of the setup process, each LEB may be marked with a unique sticking mark: a sheet of stickers with random symbols may be provided with the set of LEBs.

### Remote Control Device

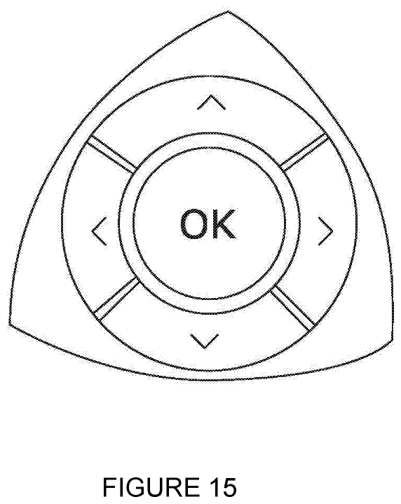

A BPU system remote control device may be a simple Bluetooth low energy (Bluetooth LE or BLE) device used for remote control of the BPU. The Remote control may have five buttons: Up, Down, Left, Right and OK. An example is shown in FIG. 15. The Remote control device may be powered from a standard CR2032 battery. A CR2032 battery is a button cell lithium battery rated at 3.0 volts.

The main function of the Remote control may be to switch HDMI inputs when a user presses a button (Left and Down buttons may switch backward, Up, Right and OK buttons may switch forward). FIG. 15 shows a Remote control device example.

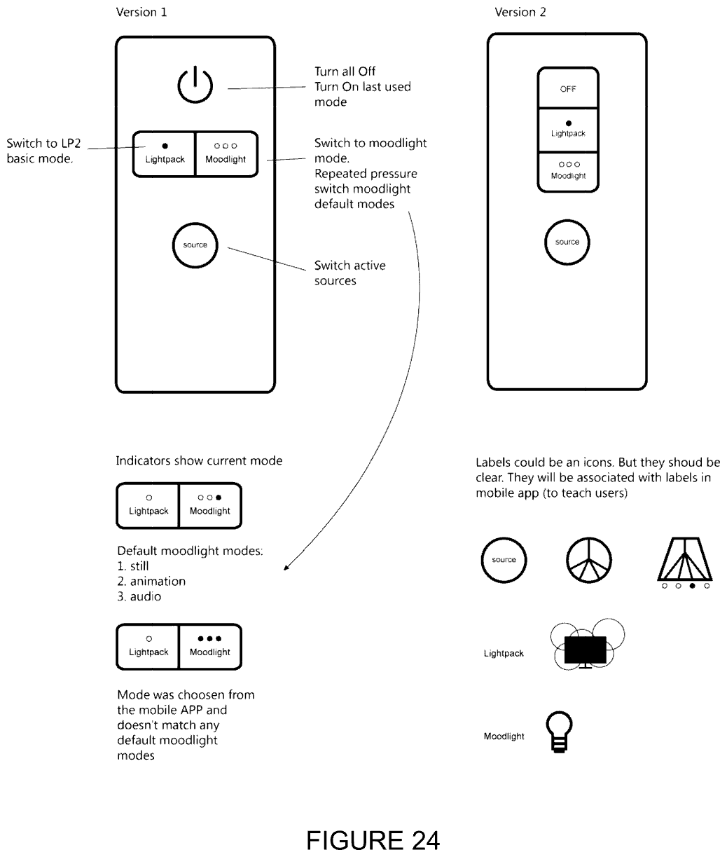

FIG. 24 shows some Remote control device examples.

### LightBridge

LightBridge is a WiFi/BLE bridge which interconnects BPU system devices (e.g. BPU main device, Remote control and LEBs) with third party devices such as smartphones, tablet PCs, smart sensors, or smart lightbulbs, via Bluetooth and WiFi, and almost any other device via Internet.

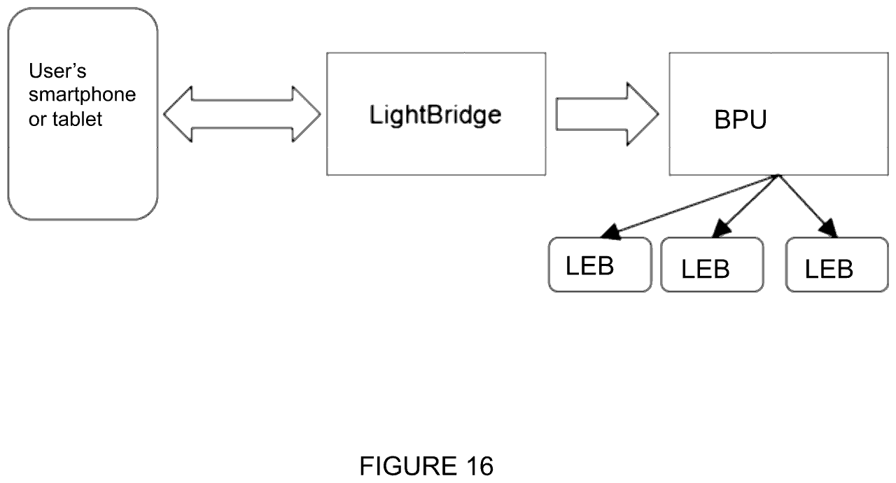

Basic use cases for LightBridge are:
Controlling a BPU device from a smartphone or tablet application e.g. via WiFi or Bluetooth (see FIG. 16 for example);

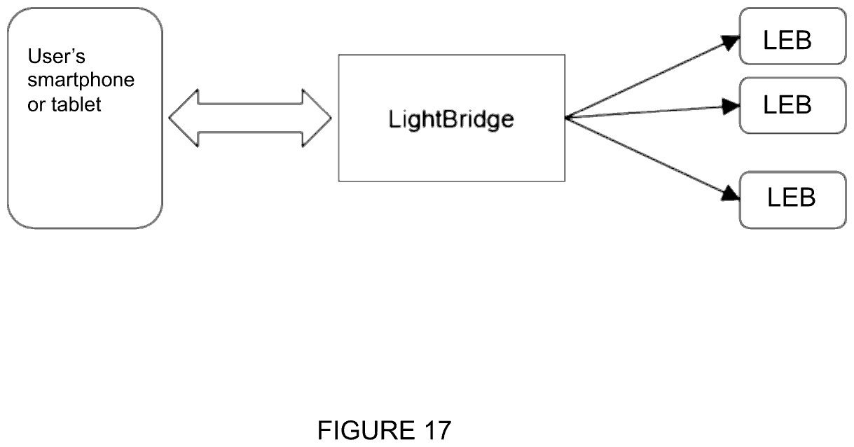

Controlling LEBs directly from smartphone or tablet application e.g. via WiFi or Bluetooth (see FIG. 17 for example);

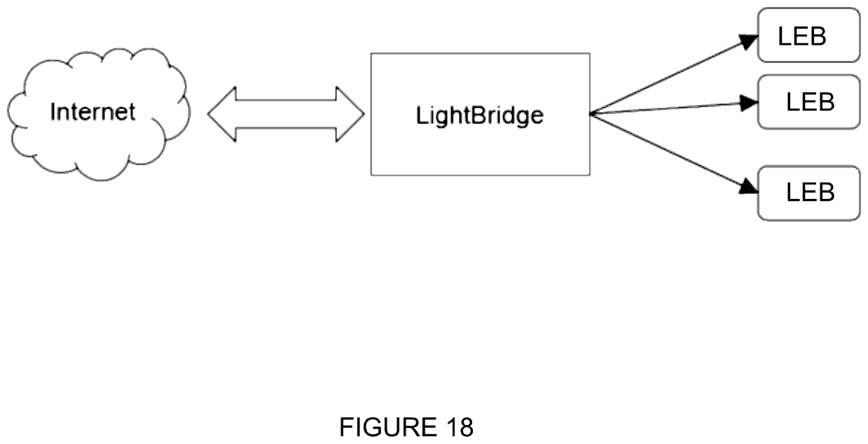

Controlling LEBs via Internet (see FIG. 18 for example);

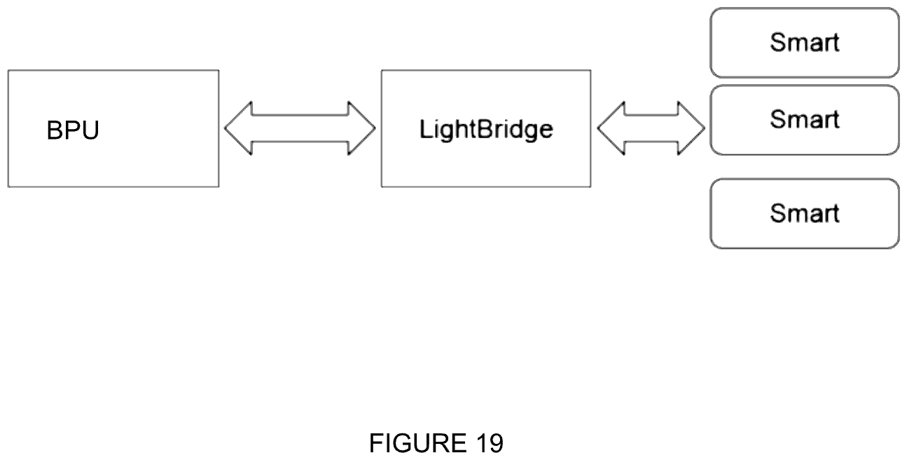

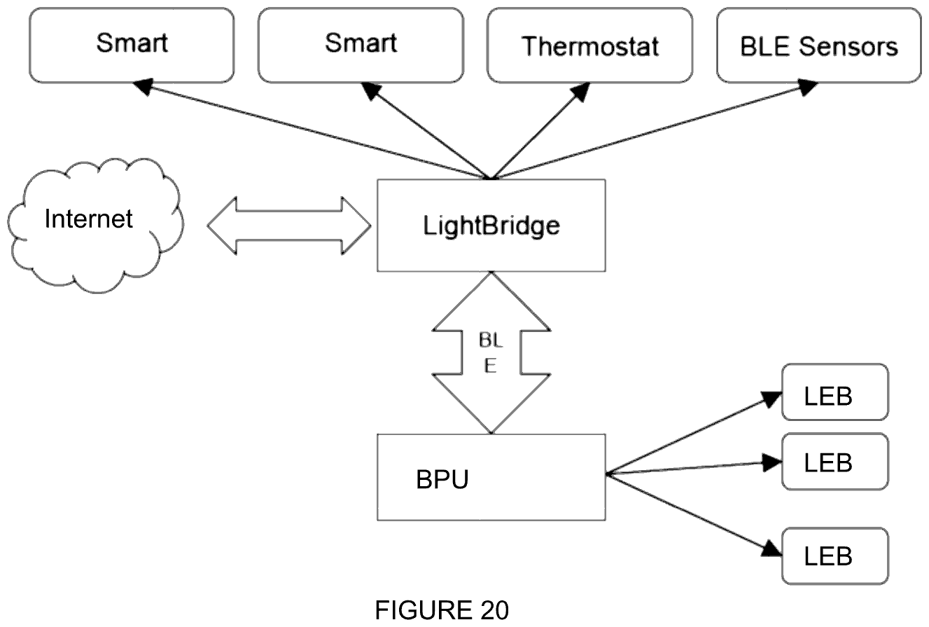

Controlling third-party smart lightbulbs from BPU (see FIG. 19 for example);
Smart Home hub (see FIG. 20 for example).

LightBridge may be a USB stick, and if so it should be inserted into a USB power source, e.g. to an electricity socket adapter which comes with the device. Also, it has WiFi/Bluetooth antenna. LightBridge's PCB could come pre-installed with the main BPU device in which case the BPU has all the functionality of both devices by default.

### Further Details

The BPU system is a lighting set that brings you a whole new experience while watching movies by lighting the background of your TV and room.

The BPU may have 4 HDMI inputs to connect all of your media devices to your TV. The BPU system may control a LED strip that is attachable near the edges of the back of your TV and can include what we call LEBs: e.g. wireless LED-based lighting modules which may be placed on the wall around the main screen. The BPU system may use complex algorithms to process the input video signal and control the ambient backlighting effects. The result may be a huge improvement in an overall viewing and gaming experience.

There is provided a HDMI pass through hub. No computer is needed. This is compatible with any HDMI source. The LED ribbon fits any screen size. There are provided e.g. 4 HDMI inputs, to plug in all your devices. Smart corners are provided, which autodetect LED ribbon length. The BPU system backlighting is provided for any TV or monitor: it is precise, bright and colourful.

The BPU may work with a wide variety of TV screens and only requires just a power source and an HDMI connection. The BPU system also can be used as an intelligent lighting system, even when your TV is off. You can set up the mood light with a BPU App e.g. running on a smartphone.

### LEBs

LEBs may extend your screen to the entire room, so you are in the very center of your media entertainment. You can control LEBs with the same BPU smartphone App: set up different modes, timer and other functions. Each LEB may have a 3 Ah battery and lasts weeks on just a single charge.

We all don't like cables and we succeeded to make LEBs work without a single one! Yes, you can place an LEB wherever you want: at the wall or other place. LEBs are connectable to a BPU via BLE and work separately or together with a BPU system's own LEDs. And only when the battery is not charged will you need to connect LEBs to the charging station.

### How it Works

The BPU analyzes the input video that feeds to your TV—whether it's a movie or a game—and lights up the entire room with corresponding colors.

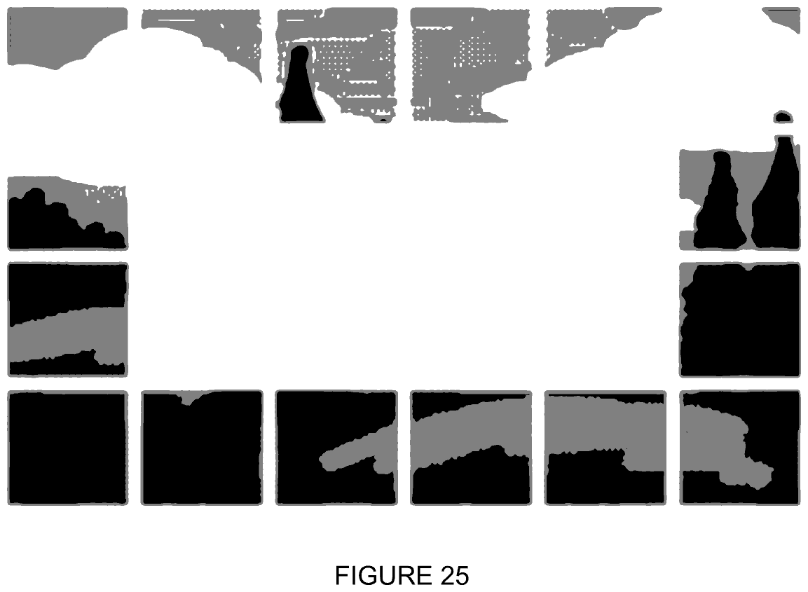

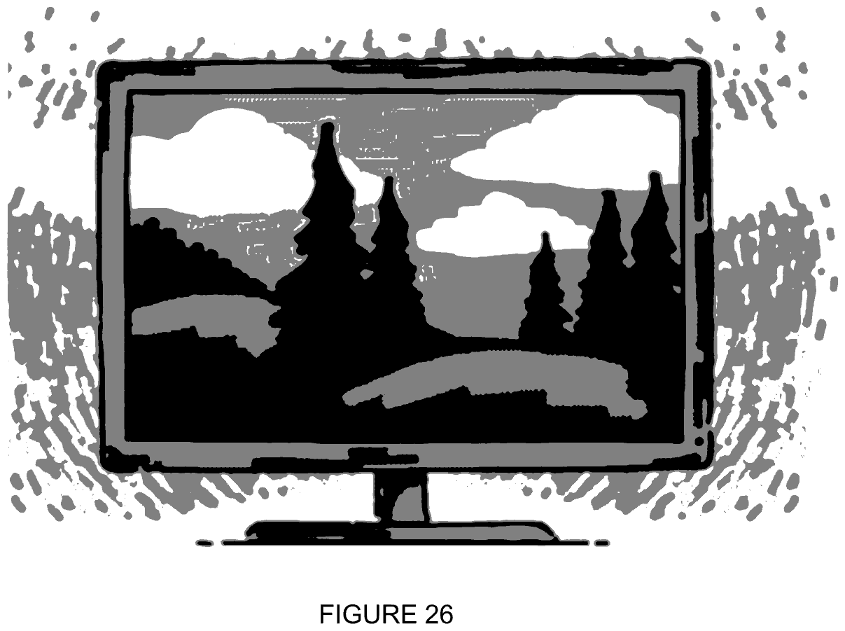

In Step 1, a new frame arrives in the BPU frame buffer via HDMI. In step 2, zones are extracted from the frame periphery. An example is shown in FIG. 25. In step 3, an average (e.g. median, mean or mode) colour is obtained for each zone. In step 4, every BPU system LED colour is set to match the average (e.g. median, mean or mode) colour in the respective zone. In step 5, the viewer can view the screen picture and the coloured backlighting. An example is shown in FIG. 26.

The signal is captured and processed by the BPU in real time, then fed to the TV in its original form. BPU processing algorithms capture pixel areas along the image border to determine the average (e.g. median, mean or mode) color of each of these areas. These colors are then transmitted to the respective LED modules on the back of the TV screen. The LED strips illuminate the wall behind the TV, making the colors pop out beyond the border of the screen and smoothing out the gradient between the luminance of the image and darkness of the room. This gradient makes the overall experience easier on the eyes while giving the illusion of a larger picture.

### Simple Setup

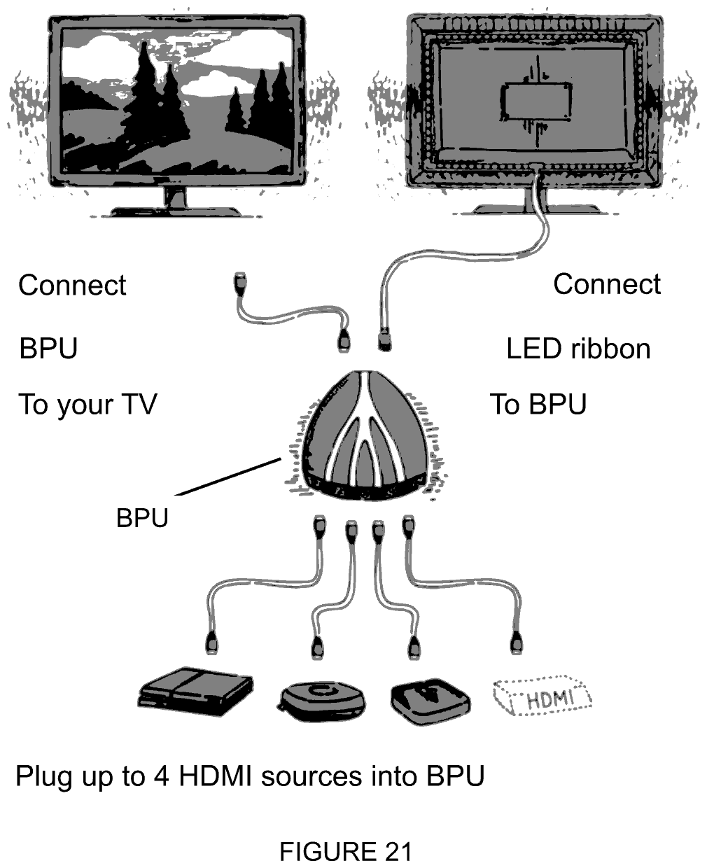

It may take 10 minutes or so to set up everything and connect your HDMI devices (e.g. HD-player, XBox, PlayStation, Nintendo Wii, Roku, Chromecast, Apple TV, PC, Mac, etc.) to a BPU system. See FIG. 21, for example.

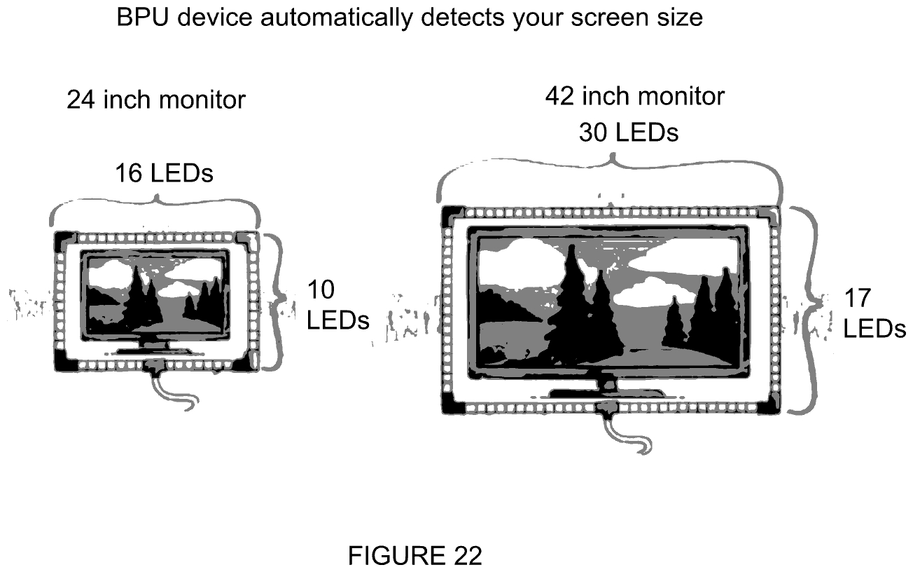

A BPU system may automatically detect your screen size. See FIG. 22, for example.

We want you to get the most from your screen, whatever one you have, yet we don't want you to struggle with complicated settings and the like. So we made SmartCorners. These little devices are what helps the BPU system to know what size is your screen is. Take the LED ribbon which comes with the BPU system, cut and stick it on each side of your TV from the back, mount the SmartCorners and you are all set.

### Mobile App

To allow you to manage your environment and control the inputs, we've developed a mobile app. It's available e.g. for iOS and Android, and with it you can switch HDMI inputs, select a setting for the Moodlight mode, and more.

### Moodlight Mode, Moodlight Dreams

In moodlight mode, the BPU lights the room as an ambient light by itself, while your TV is off. The lighting changes with time, according to an algorithm, which may be a Moodlight Dreams algorithm.

The whole BPU system (BPU and LEBs, including light emitting toroidal polyhedron) can “dream” itself an image to make a colorful backlight even when the HDMI source is off. These “dreams” are dynamic, procedurally generated “pictures” shown with the BPU backlighting system and LEBs. Adjusting the parameters of procedural generation we can make different “dreams”

The algorithm of such “dream” may be as follows.

The algorithm consists of, or includes, the following steps:

1. We make a [start] two-dimensional array with width equal to horizontal LED zones count and height equal to vertical LED zones count.
2. Using noise algorithm (e.g. Perlin Noise, Gaussian Noise) we fill the array with random values from 0 to 1. We use the parameters of noise generation such as: distance between peaks, smoothness, contrast, variability, to generate different noise patterns for different “dreams”.
3. We convert values in the array to RGB-colors using simple logic: if the value is between X1 and Y1, then the color is C1, if the value is between X2 and Y2, then the color is C2, and so on. These values (X's and Y's) and colors are defined by the particular “dream” preset.
4. We interpolate and smooth the picture in the array.
5. We generate the second [finish] array using the same algorithm.
6. We start the backlighting cycle:
the color for each LED zone and LEB is calculated as always, but as a picture for processing we use a product of time linear interpolation between the first and second arrays.

the count of steps (frames) of the interpolation is also defined in the “dream” preset, so we could make moving color transitions with different speeds.

when we get to the [finish] array, we make it [start] and generate new [finish] array to move forward.

### Eyes Protection

Remember how as kids, we were told not to sit up close to the TV at night because watching it in the darkness was harmful for the eyes? But it was such a great way to completely immerse in what was going on on the screen!

When the screen is the only source of light in a dark room, rapidly changing between dimly and brightly lit scenes on the display makes your pupils constantly change size, ranging often between 1 mm and 8 mm. It takes the pupils about 5 seconds to contract, and up to 5 minutes to expand once it gets darker. That makes your extraocular muscles work extra hard, possibly leading to vision problems.

An ambient backlight levels out the intensity of light in your room by reducing or completely eliminating the difference in overall brightness of the environment between dark and bright scenes.

### How the BPU System Protects Your Eyes

Time is necessary for your eye pupil to adapt its diameter to the light intensity while switching from dark to bright scenes.

Every action movie or game, of course, switches from dark to bright scenes many times. The BPU system can compensate these rapid changes of light emitted from the screen simply by ambient backlight provision, even in dark scenes.

In an example, a 42 inch screen diagonal length TV is viewed from 10 feet (about 3 m). The viewer's eye anatomy can't focus on the whole field of view. So the eye perceives the TV such that most of the field of vision is unfocused, and the viewer perceives the solid picture only due to brain capabilities. The peripheral vision sees an area equivalent to about a 50 inch screen diagonal length TV set.

The BPU system takes advantage of another feature of human vision: only a very small part of the retina (which is called the “macula”) can actually distinguish all the smallest details of a picture, with the rest of the picture being fuzzy for the rest of the retina.

In fact, the very smallest part of the macula (called the fovea) and the farthest part of it from the pupil can recognize the depth of field of a picture. This means that while watching TV you can only see in focus a very small part of the picture on the screen (its size depends on the distance between your eye and the screen).

Your brain then works efficiently to combine this small, focused part and the rest of the scene into a coherent picture. Using the soft illumination of a BPU system, which extends the actual picture on the screen, you see your 42-inch TV as if it were a SO-inch home theatre screen.

### Kits of Parts

The following kits of parts may be provided.

Mini Set: BPU, LED Ribbon, Smart Comers, HDMI cable, Remote control.

Room Set: Mini Set with Wi-Fi+Sx LEBs, 5 LEBs Charging Pad.

3) Super Set: Mini Set with Wi-Fi+10×LEBs, 2×5 LEBs Charging Pad, one light emitting toroidal polyhedron.

UHD Mini Set: BPU UHD, LED Ribbon, Smart Corners, HDMI cable, Remote control.

UHD Room Set: UHD Mini Set+Sx LEBs, 5 LEBs Charging Pad.

6) UHD Super Set: UHD Mini Set+10×LEBs, 2×5 LEBs Charging Pad, one light emitting toroidal polyhedron.

### Technologies

A BPU may use an FPGA controlled by a generic microcontroller.

The technology breaks down image resolutions (from e.g. 320×240 to e.g. 1080p) into a number of smaller areas, then calculates the average (e.g. median, mean or mode) color values for each of the areas.

The resolution of a given picture is detected the moment it's changed by the HDMI source, and all the captured areas are scaled to fit the new resolution. For example, the area width equals the picture width divided by the horizontal module number—while the height equals picture height divided by the vertical module number. An example BPU system diagram is shown in FIG. 9.

An open application programming interface (API) is provided that may enable access to the full scope of BPU functionality. Using the BPU base, you'll then be able to take further control over various BLE devices and sensors.

A BPU may be a WiFi-Bluetooth Smart router, which connects the LEBs with your home router via WiFi. Lightbridge is a part of a BPU system which connects a BPU to your home network and Internet. With Lightbridge, you can control the entire lighting system remotely, connect it to external services like IFTTT, and extend its functionality with third party software. IFTTT is a web-based service that allows users to create chains of simple conditional statements, called “recipes”, which are triggered based on changes to other web services such as Gmail, Facebook, Instagram, and Pinterest. IFTTT is an abbreviation of “If This Then That”.

### BPU System Development

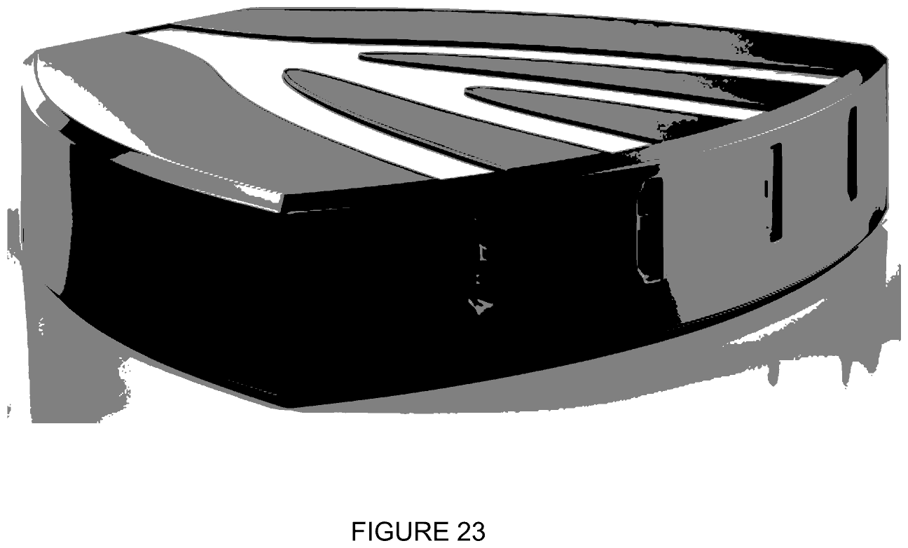

An example of a BPU is shown in FIG. 23.

Since standard microcontroller units (MCUs) were not fast and reliable enough to process 1080p@60 fps video, we had to choose an FPGA and discover for ourselves the very new sphere of the FPGA programming. Then, after the first prototype was built and tested, we had to make it work with an addressable LED ribbon. We decided to let the user choose how many LEDs he wants and made our BPU system extendable—you just cut the provided LED strip to the desired length.

Then came an idea to make all of the room environment interactive and light it up synchronously with the picture on your screen—that's how the LEBs were born.

These little glowing boxes are made autonomous and controllable over Bluetooth Low Energy—so you can place them anywhere in your room and they will turn it to an interactive light environment.

So after we had a few prototypes of LEBs working and shining (it was quite a challenge making it glow with a flat smooth light with no shadows on the edges, like a screen pixel does), we all agreed that the light was awesome, so we made LEBs a part of a BPU system.

We found that accelerometer-enabled LEBs are very fun to play with and could be connected to many devices we had at hand like radio-controlled robot platforms. Then we thought: “Hey, let's connect it to a PC and use it as a game controller!” So we made a 15-minute game prototype in GameMaker Studio and used LEB to control the in-game car.

In an example, for a BPU system, HDMI 1.4b support may be provided (e.g. up to 1080p at 60 fps, or 4K at 30 fps).

For a BPU system, HDMI 4K support may be provided, with support for HDMI 2.0 (e.g. up to 4K at 60 fps) and High-bandwidth Digital Content Protection (HDCP) 2.2.

The BPU base device may be 135×115×30 mm. Power consumption may be 25-40 W, depending on LED ribbon length.

With the flexible architecture of a BPU system, designing the performance update to the initial version may be done. We may need to upgrade two essential chips, the video processing engine and also the HDMI switch system on a chip (SoC) with more powerful (and, alas, more expensive) options. The new chips are HiFi-grade, the kind you may find in the latest receivers from B&O, Sony, Marantz and the likes. New chips also mean a few hundred more man-hours of development, along with significant additional prototyping, quality assurance (QA), and certification costs.

As an extra bonus for everyone, all BPU systems support custom settings for TV delay. If you have supersampling enabled on your TV, it typically has a 0.5-1.5 sec delay from the input signal to display and you may adjust a BPU system accordingly.

A BPU system architecture may be designed around a zero latency design, meaning there is no delay in a video signal. That's good for home cinema enthusiasts —your audio played through HiFi-centres will be perfectly synchronized with video, and for gamers, where latency matters.

We also have a goal regarding BPU compatibility for extra large TV, where 5 meters of LED ribbon is not enough. We provide an additional 5 meters of LED ribbon as an accessory in a BPU system, so you will be able to cover up to 10 meters.

With our smartwatch app, a user may control a BPU system: e.g. turn off light, change mood colors, switch on music visualization and other functions. The app may be available on Apple Watch, Android Wear, and Pebble, for example.

We may bring LEBs support for smaller BPU systems. It is possible to add Lightbridge to every BPU system we make.

### Large TVs

For users with IMAX-sized TVs and projectors, we are happy to offer additional 3 meter LED Ribbons. Our LED ribbons are custom-made, 32 lights-per-meter strips that allow every light to be addressed and controlled individually, as opposed to regular LED strips where all lights are either on or off simultaneously. Also, the color accuracy of our LEDs is much better. Additional LED Ribbons may come packaged like a film reel.

### Sensor Cube

Sensor Cube is a small box (the same 70×70×70 mm as an LEB example, but in charcoal black) that contains a set of sensors, for example:
A high sensitivity microphone to enable music visualization even without a smartphone or HDMI audio input;
A light sensor to drive LEBs and LED strips in tune with ambient light conditions;
A motion sensor to help the device understand when someone's in the room to unleash the true range of BPU colors.

In addition to BPU system data, a Sensor Cube feeds its data to a mobile app. The most enthusiastic users may use our API to connect Sensor Cube to their smart home systems and get in control of their climate, security, and music environment. Sensor Cube allows discovery of new feelings between your home and the BPU system.

### LEB

How LEBs are adjustable by default:
On LEB turning on (from state OFF to ON—by physical switch) it connects to a BPU system. The BPU adjusts zone by default for every LEB.
   Note: we adjusting zones by default. So user gets working system without any preferences setup.
Zone of capture for every LEB is adjusted automatically. It depends on TV size, defined as 10% of TVs perimeter by default.
LEBs connect to the BPU system one by one. Zones of every LEB adjust randomly.
LEB has adjusting in memory even when turned off
When LEB has zone adjusted—it works automatically.

### LEB Prototype Capabilities

Gestures

Shake

Tap, Double Tap

Rotate

Standing still

Move

### States of LEB:

Off

Stand by

BPU system sync

Movement (flying LEB)

Candle light

### BPU System Sync Mode

Turning on by turning on/off source

Works by default

### Movement Mode (Flying LEB)

Activates automatically when moved.

LEB lights with mild pink color (subject to change) with blinking

When LEB stops to move, it slowly gets darker until off within 2-3 seconds. Then switches to previous mode.
When LEB switches to Movement Mode, zone of led stripe adjusted to it starts to blink.

If 2 or more LEB are in Move Mode:

Var1: Each LEB and zone colored to different color.

Var2: Color LEB white and no reaction on stripe. User have to move only one LEB at once.

### Candle Light Mode

Mode turning on by shaking LEB one time.

Multiple shake is detected as single one.

When in Candle mode—LEB lights white on full brightness.

LEB stays on until battery drained out.

Mode is disabled by single shake.

### Zone Adjusting Mode

Turning on in any mode by double tap.

When at least 1 LEB is in Zone Adjusting Mode, led stripe switches to this mode too. Zone on stripe markered by 3-4 LEDs on full brightness.

In Zone adjusting mode blinks with every LED color one by one: red, green, blue. Brightness on 40%.

Zone on stripe setting up by turning LEB clockwise/counterclockwise.

When idle more than 1 sec—switches back to previous mode.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. An apparatus including a backlighting processor unit (BPU), and a colour illumination system which is connectable to the backlighting processor unit, the colour illumination system attachable to a reverse side of a display, wherein the display is positionable facing away from a vertical surface, the backlighting processor unit arranged to receive a display frame and to transmit the display frame to the display, the backlighting processor unit further arranged to process the display frame, and to control the colour illumination system to output a colour, at an intensity, wherein the colour is obtained from the processing of the display frame, the output colour being output at the intensity towards the vertical surface.

2. The apparatus of claim 1, wherein the colour is obtained from the processing of the display frame, using an averaging process for at least a portion of the display frame.

3. The apparatus of claim 1, wherein the intensity is obtained from the processing of the display frame.

4. The apparatus of claim 3, wherein the intensity is obtained from the processing of the display frame, using an averaging process for at least a portion of the display frame.

5. The apparatus of claim 1, wherein the colour illumination system comprises a plurality of light output sources.

6. The apparatus of claim 1, wherein the colour illumination system comprises a plurality of light sources, wherein the colour of each respective light source is selected by the BPU as a result of analyzing a respective zone of the display frame which is closest to the respective light source.

7. The apparatus of claim 5, wherein processing includes capturing pixel areas along the border of an image and obtaining an average (e.g. a median, mean or mode) color of each of these areas.

8. The apparatus of claim 7, wherein these colors are then displayed at a respective light source module on the back of the display screen.

9. The apparatus of claim 8, wherein all the light sources on the back of the display device work together to illuminate e.g. a wall behind the display making an image which extends screen borders and provides a light gradient between a bright image on the display and a dark ambient of a room.

10. The apparatus of claim 9, wherein the gradient helps to relieve eye strain and make a visually larger picture.

11. The apparatus of claim 5, wherein the colour illumination system comprises a chain of LED light output modules.

12. The apparatus of claim 11, wherein each chain element module comprises RGB LEDs assembled in a plastic housing with a transparent top part.

13. The apparatus of claim 11, wherein each chain element module has an adhesive layer at the bottom.

14. The apparatus of claim 5, wherein the colour illumination system comprises clip-corners and a set of LED strips, in which the set of LED strips are connectable using the clip-corners.

15. The apparatus of claim 14, wherein the set of LED strips is 1 m to 5 m in length.

16. The apparatus of claim 14, wherein the set of LED strips is 5 m to 10 m in length.

17. The apparatus of claim 14, wherein each clip corner includes a PCBA (printed circuit board assembly) with a microcontroller.

18. The apparatus of claim 14, wherein each clip corner is assembled in a plastic housing with plastic clamping clips, which makes a secure electrical connection and mechanically fastens strips inside the clip-corner.

19. The apparatus of claim 1 wherein the apparatus includes a plurality of light emitting boxes, which are connectable to the BPU.

20. The apparatus of claim 19, wherein the plurality of light emitting boxes includes a light emitting toroidal polyhedron.

21. The apparatus of claim 19, wherein each light emitting box device lights up with an average (e.g. median, mean or mode) color of a picture being shown on the display, e.g. if picture's overall luminosity is higher than a threshold value.

22. The apparatus of claim 19, wherein each light emitting box device lights up with an average (e.g. median, mean or mode) color of the picture area which it is assigned to.

23. The apparatus of claim 19, wherein each light emitting box device has an accelerometer and a gyroscope which are usable in a setup process.

24. The apparatus of claim 23, wherein the BPU device determines the position of each connected LEB relative to the display screen, based on data gathered from the LEB's accelerometer and gyroscope while a user sets up each LEB.

25. A method of installing an apparatus including a backlighting processor unit (BPU), and a colour illumination system which is connectable to the backlighting processor unit, wherein the backlighting processor unit is arranged to receive a display frame and to transmit the display frame to the display, the backlighting processor unit further arranged to process the display frame, and to control the colour illumination system to output a colour, at an intensity, wherein the colour and the intensity are obtained from the processing of the display frame, the output colour being output at the intensity towards a vertical surface, the method comprising the steps of:
(i) attaching the colour illumination system to a reverse side of a display, wherein the display is positionable facing away from the vertical surface, and
(ii) connecting the colour illumination system to the BPU.

26. A display apparatus including a screen, a backlighting processor unit (BPU), and a colour illumination system in connection with the backlighting processor unit, the colour illumination system situated on a reverse side of the display apparatus to the screen, wherein the display is positionable with the screen facing away from a vertical surface, the backlighting processor unit arranged to receive a display frame and to transmit the display frame to the screen, the backlighting processor unit further arranged to process the display frame, and to control the colour illumination system to output a colour, at an intensity, wherein the colour is obtained from the processing of the display frame, the output colour being output at the intensity towards the vertical surface.
